(19) United States
(12) Patent Application Publication
(10) Pub. No.: US 2012/0224169 A1
(43) Pub. Date: Sep. 6, 2012

(54) OPTICAL FIBER VIBRATION SENSOR

(75) Inventors: Tatsuya KUMAGAI, Hitachi (JP); Shinobu Sato, Hitachinaka (JP)

(73) Assignee: Hitachi Cable, Ltd., Tokyo (JP)

(21) Appl. No.: 13/371,877

(22) Filed: Feb. 13, 2012

(30) Foreign Application Priority Data
Mar. 4, 2011 (JP) 2011-047571
Jan. 25, 2012 (JP) 2012-012847

(51) Int. Cl. G01B 9/02

(52) U.S. Cl. 356/73.1

(57) ABSTRACT

A Sagnac interference type optical fiber vibration sensor includes two optical fiber loops arranged along a structure, and a vibration sensor main body which detects the vibration caused to the structure via the two optical fiber loops. A sensitivity of one of the two optical fiber loops for detecting a vibration decreases with a distance from one end to an other end, while a sensitivity of an other of the two optical fiber loops increases with a distance from the one end to the other end. The main body includes a portion for determining whether the vibration occurred to the structure based on a sum of outputs produced via the two optical fiber loops, and a portion for determining a position where the vibration occurred based on an output ratio which is a difference between the outputs produced which is divided by the sum of the outputs produced.

The present application is based on Japanese patent application No 2011-047571 filed on Mar. 4, 2011 and Japanese patent application No 2012-012847 filed on Jan. 25, 2012, the entire contents of which are incorporated herein by reference.

### BACKGROUND OF THE INVENTION

1. Field of the Invention

The present invention relates to an optical fiber vibration sensor, in which optical fibers are fixed to a structure such as a fence or the like, for detecting mechanical vibration applied to the optical fibers, thereby detecting an intruder or the like, more particularly, to a Sagnac interference type optical fiber vibration sensor.

2. Description of the Related Art

In order to restrain an intruder from committing burglary or destruction, or leaking information, or in order to ensure physical security, interests on physical security technologies are increasing. Particularly, in important facilities such as airports or ports and harbors, power stations, or the like, a fence has been provided on the boundary of the site to take a measure to prevent illegal intrusion. However, there has been a limit to the physical height or strength of the fence, and therefore there has been a need to further install an intrusion sensor for detecting the illegal intrusion.

A vibration sensor, which is fixed to a structure such as a fence or the like for detecting vibration of that structure, has been noted as such an intrusion sensor. In particular, a Sagnac interference type optical fiber vibration sensor using a Sagnac interference system has been noted because the reduction in cost or the durability in the field can be expected.

FIG. 13 shows a conventional Sagnac interference type optical fiber vibration sensor 131. In this optical fiber vibration sensor 131, a part of an optical fiber loop 132 is used as a vibration sensor portion, and this optical fiber loop 132 is arranged along a structure such as a fence or the like.

In this optical fiber vibration sensor 131, a light wave emitted from a light source 133 is propagated through a first optical coupler 134, linearly polarized by a polarizer 135, and split by a second optical coupler 136 into two light waves. The two split light waves are then input to different ends, respectively, of the optical fiber loop 132. One of the two light waves input to the optical fiber loop 132 is referred to as a clockwise light wave L_{CW}, while the other thereof is referred to as a counterclockwise light wave L_{CCW}.

These clockwise light wave L_{CW} and counterclockwise light wave L_{CCW} are phase modulated by a phase modulator 137 on the optical fiber loop 132, and passed all around (i.e. propagated through one circuit of) the optical fiber loop 132, again input into the second optical coupler 136. At the second optical coupler 136, the clockwise and counterclockwise light waves L_{CW} and L_{CCW} input to the second optical coupler 136 interfere with each other, resulting in an interfering light wave. This interfering light wave is propagated through the polarizer 135, and again split by the first optical coupler 134 into two light waves, and one of the two split light waves is received in a light receiver 138.

When the optical fiber loop 132 does not vibrate, the light receiver 138 detects a constant light intensity at all times. On the other hand, when the optical fiber loop 132 vibrates, the clockwise and counterclockwise light waves L_{CW} and L_{CCW} have a phase difference, and the light intensity detected by the light receiver 138 varies. A signal processing unit 139 detects this variation in the light intensity, thereby detecting the vibration of the optical fiber loop 132.

However, the optical fiber vibration sensor 131 as shown in FIG. 13 has a disadvantage in that both the clockwise and counterclockwise light waves L_{CW} and L_{CCW} pass through the vicinity of a halfway point around the optical fiber loop 132 substantially at the same time, so that the phase difference between the light waves L_{CW} and L_{CCW} is unlikely to be caused by vibration, thereby lowering the sensitivity for detecting the vibration. Particularly, at the halfway point around the optical fiber loop 132, the sensitivity for detecting the vibration is zero.

In order to overcome this disadvantage, JP-A-2008-309776 has suggested an optical fiber vibration sensor, in which at least half a length of an optical fiber constituting an optical fiber loop is accommodated in a vibration sensor main body as a delaying optical fiber and the halfway point of the optical fiber loop, where the detection sensitivity is zero, is disposed within the vibration sensor main body (or an exit of the vibration sensor main body). According to this structure, the detection sensitivity in the longitudinal direction of the optical fiber loop can be made uniform, so that the sensitivity for detecting the vibration can be improved.

Also, in recent years, there have been needs for e.g. not only detecting an intruder, but also identifying the intrusion position information on from where the intruder has intruded by using the Sagnac interference type optical fiber vibration sensor.

Accordingly. JP-A-2010-48706 has suggested an optical fiber vibration sensor, in which optical fiber loops having different lengths are arranged along a structure such as a fence or the like. According to this structure, it is possible to identify which region the vibration occurred based on the combination of the optical fiber loops which have detected the vibration.

### SUMMARY OF THE INVENTION

However, the above optical fiber vibration sensor of JP-A-2010-48706 has the disadvantage in that the number of optical fiber loops should be increased for more minutely identifying a position where the intruder has intruded, i.e. the vibration occurred. Therefore, a device configuration is complicated and therefore the cost is increased.

Accordingly, it is an object of the present invention to provide an optical fiber vibration sensor, which has good detection sensitivity over the entire longitudinal length, and is capable of minutely identifying a position where an intruder has intruded.

According to a feature of the invention, a Sagnac interference type optical fiber vibration sensor comprises:

two optical fiber loops arranged along a structure, at least respective longitudinal portions of the two optical fiber loops being arranged along each other such that a sensitivity of one of the two optical fiber loops for detecting a vibration decreases with a distance from one end to an other end, while a sensitivity of an other of the two optical fiber loops for detecting the vibration increases with a distance from the one end to the other end; and

a vibration sensor main body, which detects the vibration caused to the structure, via the two optical fiber loops, the vibration sensor main body including:

a vibration occurrence determining portion for determining whether the vibration occurred to the structure based on a sum of outputs produced via the two optical fiber loops; and

a vibration position determining portion for determining a position where the vibration occurred to the structure based on an output ratio,

in which the output ratio is a difference between the outputs produced via the two optical fiber loops which is divided by the sum of the outputs produced via the two optical fiber loops.

The two optical fiber loops may be arranged in mutually opposite orientations, in which a tip end of the other optical fiber loop is positioned on a base end side of the one optical fiber loop, and a base end of the other optical fiber loop is positioned on a tip end side of the one optical fiber loop.

The optical fiber vibration sensor may further comprises a common phase modulator comprising a common cylindrical piezo ceramic element wound with portions of optical fibers constituting each of the two optical fiber loops.

The vibration position determining portion may determine that the vibration occurred in a region in which only one of the two optical fiber loops detecting the vibration is arranged, when the vibration is detected at only the one of the two optical fiber loops.

According to another feature of the invention, a Sagnac interference type optical fiber vibration sensor comprises:

two optical fiber loops arranged along a structure, at least respective longitudinal portions of the two optical fiber loops being arranged along each other such that a sensitivity of one of the two optical fiber loops for detecting a vibration is constant with a distance from one end to an other end, while a sensitivity of an other of the two optical fiber loops for detecting the vibration decreases or increases with a distance from the one end to the other end; and

a vibration sensor main body, which detects the vibration caused to the structure, via the two optical fiber loops, the vibration sensor main body including:

a vibration occurrence determining portion for determining whether the vibration occurred to the structure based on a sum of outputs produced via the two optical fiber loops, or an output produced via the one of the two optical fiber loops; and

a vibration position determining portion for determining a position where the vibration occurred to the structure based on an output ratio of the outputs produced via the two optical fiber loops.

The one of the two optical fiber loops may include a delaying optical fiber comprising an optical fiber having at least half an entire length of optical fibers constituting the one of the two optical fiber loops, and the delaying optical fiber may be accommodated in the vibration sensor main body.

The two optical fiber loops may have a common orientation, in which respective base ends and tip ends of the two optical fiber loops are aligned with each other and a length of the one of the two optical fiber loops is not less than a length of the other of the two optical fiber loops.

The vibration occurrence determining portion may determine that the vibration occurred to the structure is caused by a natural phenomenon, if the vibration occurrence determining portion determines that the vibration occurred to the structure but the vibration position determining portion cannot determine the position where the vibration occurred to the structure.

### Points of the Invention

According to one embodiment of the invention, two optical fiber loops are arranged along a structure, and at least respective longitudinal portions of the two optical fiber loops are arranged along each other such that a sensitivity of one of the two optical fiber loops for detecting a vibration decreases with a distance from one end to an other end, while a sensitivity of an other of the two optical fiber loops for detecting the vibration increases with a distance from the one end to the other end, and a vibration sensor main body includes a vibration occurrence determining portion for determining whether the vibration occurred to the structure based on a sum of outputs produced via the two optical fiber loops, and a vibration position determining portion for determining a position where the vibration occurred to the structure based on an output ratio, in which the output ratio is a difference between the outputs produced via the two optical fiber loops which is divided by the sum of the outputs produced via the two optical fiber loops.

According to this structure, there is no point where the detection sensitivity is zero over the entire longitudinal length, so that it is possible to provide the good detection sensitivity over the entire longitudinal length, and more minutely pinpoint the position where the vibration occurred to the structure, i.e. the intruder has intruded.

According to another embodiment of the invention, it is possible to determine whether vibration occurred to the structure based on the sum of the outputs produced via the two optical fiber loops, or the output produced via one of the two optical fiber loops, and to determine a position where the vibration occurred to the structure based on the output ratio of the outputs produced via the two optical fiber loops.

### BRIEF DESCRIPTION OF THE DRAWINGS

The preferred embodiments according to the invention will be explained below referring to the drawings, wherein:

FIG. 1 is a schematic configuration diagram showing an optical fiber vibration sensor in a first embodiment according to the invention;

FIGS. 2A to 2D are explanatory diagrams for explaining the detection sensitivity of the optical fiber vibration sensor of FIG. 1, in which FIG. 2A shows the detection sensitivity of a first optical fiber loop, FIG. 2B shows the detection sensitivity of a second optical fiber loop, FIG. 2C shows the sum of the respective detection sensitivities of the first and second optical fiber loops, and FIG. 2D shows the detection sensitivity ratio;

FIG. 3 is a schematic configuration diagram showing a first variation of the optical fiber vibration sensor of FIG. 1;

FIG. 4 is a schematic configuration diagram showing a second variation of the optical fiber vibration sensor of FIG. 1;

FIG. 5 is a schematic configuration diagram showing a third variation of the optical fiber vibration sensor of FIG. 1;

FIG. 6 is a schematic configuration diagram showing an optical fiber vibration sensor in a second embodiment according to the invention;

FIGS. 7A to 7C are diagrams for explaining the detection sensitivity of the optical fiber vibration sensor of FIG. 6, in which FIG. 7A shows the detection sensitivity of the first optical fiber loop, FIG. 7B shows the detection sensitivity of the second optical fiber loop, and FIG. 7C shows the detection sensitivity ratio;

FIG. 8 is a schematic configuration diagram showing a first variation of the optical fiber vibration sensor of FIG. 6;

FIGS. 9A to 9C are explanatory diagrams for explaining the detection sensitivity of the optical fiber vibration sensor of FIG. 8, in which FIG. 9A shows the detection sensitivity of a first optical fiber loop, FIG. 9B shows the detection sensitivity of a second optical fiber loop, and FIG. 9C shows the detection sensitivity ratio;

FIG. 10 is a schematic configuration diagram showing a second variation of the optical fiber vibration sensor of FIG. 6;

FIG. 11 is a schematic configuration diagram showing an optical fiber vibration sensor in a third embodiment according to the invention;

FIGS. 12A to 12D are explanatory diagrams for explaining the detection sensitivity of the optical fiber vibration sensor of FIG. 10, in which FIG. 12A shows the detection sensitivity of a first optical fiber loop, FIG. 12B shows the detection sensitivity of a second optical fiber loop, FIG. 12C shows the sum of the respective detection sensitivities of the first and second optical fiber loops, and FIG. 12D shows the detection sensitivity ratio; and

FIG. 13 is a schematic configuration diagram showing a conventional optical fiber vibration sensor.

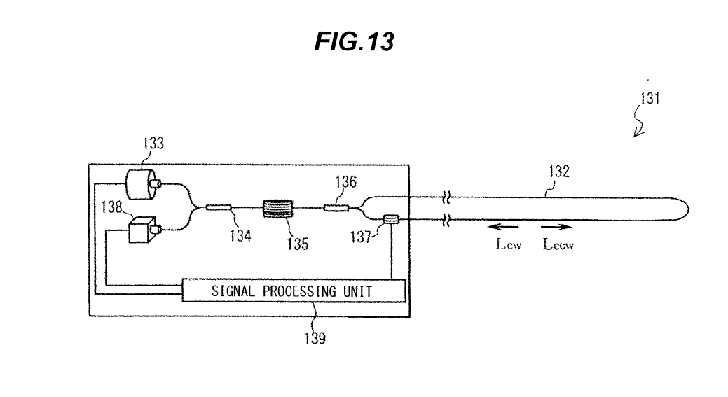

### DETAILED DESCRIPTION OF THE PREFERRED EMBODIMENTS

Next, preferred embodiments according to the invention will be described in more detail in conjunction with the accompanying drawings.

### First Embodiment

The first embodiment according to the invention is described first.

(Structure of an Optical Fiber Vibration Sensor 1)

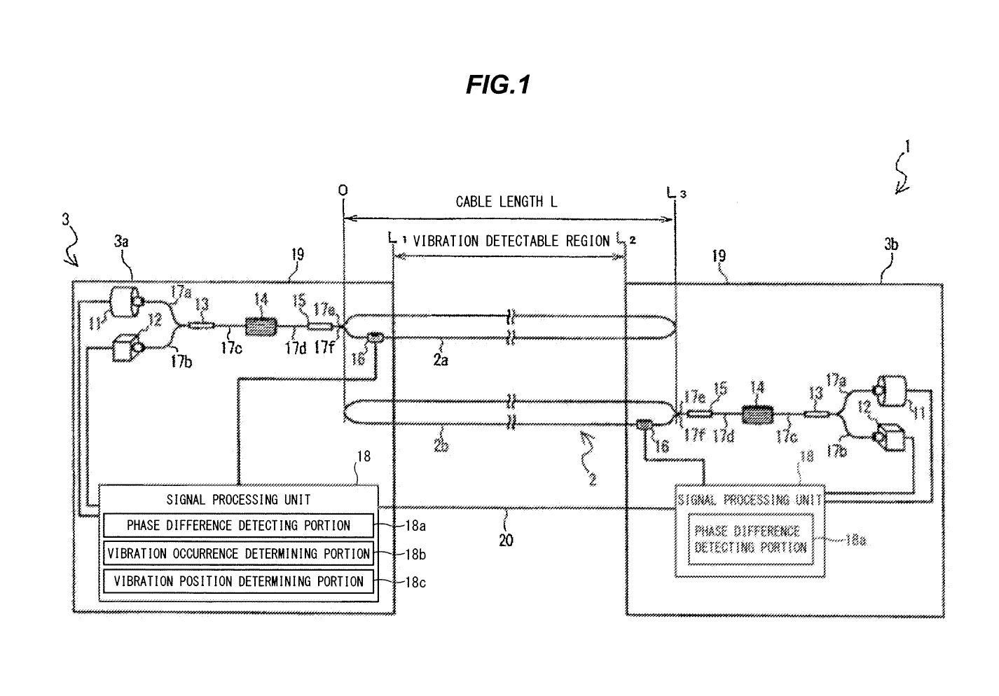

FIG. 1 is a schematic configuration diagram showing an optical fiber vibration sensor 1 in the first embodiment according to the invention.

Referring to FIG. 1, the optical fiber vibration sensor 1 includes two optical fiber loops 2 arranged along a structure (not shown) such as a fence or the like, and two vibration sensor main bodies 3 which detect vibration caused to a structure via the optical fiber loops 2.

In this embodiment, the optical fiber vibration sensor 1 includes the two optical fiber loops 2 and the two vibration sensor main bodies 3. Herein, the vibration sensor main body 3 in the left side of FIG. 1 is also referred to as a first vibration sensor main body 3a, while the vibration sensor main body 3 in the right side of FIG. 1 is also referred to as a second vibration sensor main body 3b, and the optical fiber loop 2 connected to the first vibration sensor main body 3a is also referred to as a first optical fiber loop 2a, while the optical fiber loop 2 connected to the second vibration sensor main body 3b is also referred to as a second optical fiber loop 2b.

Each of the vibration sensor main bodies 3a and 3b includes a light source 11, a light receiver 12 such as a photodiode, a first optical coupler 13 having three ports 17a to 17c to input or output light, a polarizer 14, a second optical coupler 15 having three ports 17d to 17f to input or output light, and a phase modulator 16. Each of the vibration sensor main bodies 3a and 3b further includes a signal processing unit 18, and a casing 19 for accommodating these components.

The light sources 11 may comprise e.g. an SLD (Super Luminescent Diode). By using the SLD, it is possible to reduce an interference noise resulting from interference between a return light from each of the first and second optical fiber loops 2a and 2b and a Rayleigh Scattered light.

Each of the optical couplers 13 and 15 may comprise an optical fiber coupler having 1×2 input/output ports (i.e. one input or output port and two output or input ports) as shown in FIG. 1. Alternatively, each of the optical couplers 13 and 15 may comprise an optical fiber coupler having 2×2 input/output ports (i.e. two input or output ports and two output or input ports).

In the first vibration sensor main body 3a, the first port 17a of the first optical coupler 13 is optically connected to the light source 11, the second port 17b of the first optical coupler 13 is optically connected to the light receiver 12, and the third port 17c of the first optical coupler 13 is optically connected to one end of the polarizer 14. Similarly, in the second vibration sensor main body 3b, the first port 17a of the first optical coupler 13 is optically connected to the light source 11, the second port 17b of the first optical coupler 13 is optically connected to the light receiver 12, and the third port 17c of the first optical coupler 13 is optically connected to one end of the polarizer 14.

In the first vibration sensor main body 3a, the first port 17d of the second optical coupler 15 is optically connected to an other end of the polarizer 14, the second port 17e of the second optical coupler 15 is optically connected to one end of the first optical fiber loop 2a, and the third port 17f of the second optical coupler 15 is optically connected to an other end of the first optical fiber loop 2a. Similarly, in the second vibration sensor main body 3b, the first port 17d of the second optical coupler 15 is optically connected to an other end of the polarizer 14, the second port 17e of the second optical coupler 15 is optically connected to one end of the second optical fiber loop 2b, and the third port 17f of the second optical coupler 15 is optically connected to an other end of the second optical fiber loop 2b.

The phase modulators 16 are provided adjacent to the other ends of the first and second optical fiber loops 2a and 2b, respectively. Each of the polarizers 14 is a fiber-type polarizer which has an increased core birefringence and is formed in a coil shape. The polarizer 14 serves to linearly polarize the light from the light sources 11.

Each of the phase modulators 16 serves to impose a phase modulation having a relative time delay on light waves propagating in mutually opposite directions around each of the first and second optical fiber loops 2a and 2b. Because the intensity of the light detected by the light receiver 12 is proportional to a cosine of the phase difference between the light waves propagating in mutually opposite directions around each of the first and second optical fiber loops 2a and 2b, the sensitivity for near zero phase difference, i.e. the sensitivity to slight (micro) vibration is low. Therefore, it is possible to improve the sensitivity to the slight vibration by conducting the phase modulation with the use of the phase modulator 16, thereby making the intensity of the light detected by the light receiver 12 proportional to a sine of the phase difference.

The phase modulator 16 may comprise a cylindrical piezo ceramic element (hereinafter referred to as “PZT”) as an oscillator, and a portion of an optical fiber constituting each of the first and second optical fiber loops 2a and 2b, which is wound around the PZT. The phase modulator 16 can stretch or compress the optical fibers wound around the PZT by applying voltage to the PZT, thereby modulate the phase of the light.

The signal processing unit 18 is provided for driving the light sources 11, processing electrical signals generated by photoelectric conversion of the optical signals detected by the light receiver 12, controlling a modulation level of the phase modulator 16, outputting a processed result (vibration waveform, vibration intensity, and the like), and so on. The signal processing unit 18 is electrically connected with the light sources 11, the light receiver 12, and the phase modulator 16. Each of the signal processing units 18 is mounted with a phase difference detecting portion 18a which detects the phase difference between the light waves propagated in mutually opposite directions around each of the first and second optical fiber loops 2a and 2b and emitted from both the ends of each of the first and second optical fiber loops 2a and 2b, based on the electrical signals from the light receiver 12. Further, the signal processing unit 18 of the first vibration sensor main body 3a is mounted with a vibration occurrence determining portion 18b and a vibration position determining portion 18c, which will be described later.

The respective signal processing units 18 of both the first and second vibration sensor main bodies 3a and 3b are electrically connected to each other by a cable 20, so that data is transmitted or received between each other via the cable 20 Alternatively, the data may be transmitted or received between the signal processing units 18 by wireless communication.

Each of the first and second optical fiber loops 2a and 2b is formed by joining together respective tip ends of two optical fibers arranged in parallel and along each other. Although schematically shown in FIG. 1, a twin core optical fiber cable having two optical fibers accommodated in a flexible tube is used in this embodiment. The two optical fibers are fusion spliced at tip ends of the twin core optical fiber cable, to provide respective optical fiber loops 2a and 2b In the spliced portion where the two optical fibers are spliced together, it is preferable that a bend radius of each of the optical fibers be not less than a specified bend radius (e.g. 60 mm or more), in order to reduce an optical loss (bend loss) caused in the spliced portion.

It is preferable to use a polarization maintaining fiber (PMF) as the optical fibers constituting the first and second optical fiber loops 2a and 2b. For example, if a single mode fiber (SMF) is used as the optical fibers constituting the first and second optical fiber loops 2a and 2b, two mutually orthogonal polarization eigen modes with slightly different propagation constants will propagate in the SMF, so that the mode conversion will occur due to disturbance such as vibration, temperature variation, or the like, and interference noise will be generated from this mode conversion. In order to avoid such interference noise, the polarization maintaining fiber is used as the optical fibers constituting the first and second optical fiber loops 2a and 2b. Further, it is preferable that each of optical fibers constituting each port 17a to 17f of the optical couplers 13 and 15 also comprises a polarization maintaining fiber.

In the optical fiber vibration sensor 1 in this embodiment, the two optical fiber loops 2a and 2b are arranged in such a manner that at least parts thereof in the longitudinal direction are arranged adjacent to and along each other, so that the sensitivity of one optical fiber loop 2a for detecting vibration decreases with distance from one end (the left end shown in FIG. 1) to the other end (the right end shown in FIG. 1), while the sensitivity of the other optical fiber loop 2b for detecting vibration increases with distance from one end (the left end shown in FIG. 1) to the other end (the right end shown in FIG. 1). According to such adjacent arrangement of the optical fiber loops 2a and 2b, it is possible to detect the same vibration.

As described above, because the light waves traveling clockwise and counterclockwise respectively around each of the first and second optical fiber loops 2a and 2b pass the vicinity of the halfway point (i.e. the tip end) substantially at the same time, the phase difference between the light waves is unlikely to be caused by the vibration in the vicinity of the halfway point, and the sensitivity for detecting the vibration gradually decreases with distance from the base end to the tip end of each of the first and second optical fiber loops 2a and 2b, and finally the sensitivity for detecting the vibration is zero at the halfway point around each of the first and second optical fiber loops 2a and 2b. Therefore, in this embodiment, the two optical fiber loops 2a and 2b are arranged to have such mutually opposite orientations that the tip end of the second optical fiber loop 2b is positioned on the base end side of the first optical fiber loop 2a, while the base end of the second optical fiber loop 2b is positioned on the tip end side of the first optical fiber loop 2a.

Also, in this embodiment, the two optical fiber loops 2a and 2b are formed to have the same length (referred to as “cable length”) L, and are configured to be arranged in parallel and along each other over the entire length thereof. The tip end of the first optical fiber loop 2a is received in the second vibration sensor main body 3b, while the tip end of the second optical fiber loop 2b is received in the first vibration sensor main body 3a.

In this embodiment, the region between both the first and second vibration sensor main bodies 3a and 3b is the vibration detectable region (i.e. “measurement region”). Herein, when the base end of the first optical fiber loop 2a (the tip end of the second optical fiber loop 2b) is taken as a reference point 0, the distance from the reference point 0 to a casing 19 for the first vibration sensor main body 3a is set at L₁, the distance from the reference point 0 to a casing 19 for the second vibration sensor main body 3b is set at L₂, and the distance from the reference point 0 to the tip end of the first optical fiber loop 2a (the base end of the second optical fiber loop 2b) is set at L₃ (L₃ is equal to the cable length L of the first and second optical fiber loops 2a and 2b). In this case, the vibration detectable region ranges from the distance L₁ to the distance L₂.

The optical fiber vibration sensor 1 in this embodiment includes the vibration occurrence determining portion 18b for determining whether vibration occurred to the structure based on a sum of outputs produced via the two optical fiber loops 2a and 2b, and a vibration position determining portion 18c for determining a position where the vibration occurred to the structure based on an output ratio, in which the output ratio is calculated by dividing a difference between the outputs produced via the two optical fiber loops 2a and 2b by the sum of the outputs produced via the two optical fiber loops 2a and 2b (i.e. the output ratio is a difference between the outputs produced via the two optical fiber loops which is divided by the sum of the outputs produced via the two optical fiber loops). Herein, the vibration occurrence determining portion 18b and the vibration position determining portion 18c are mounted in the signal processing unit 18 of the first vibration sensor main body 3a. The “output” herein refers to the phase difference detected by the phase difference detecting portions 18a.

Also, the optical fiber vibration sensor 1 is equipped with an alarm means (not shown), and the vibration occurrence determining portion 18b of the signal processing units 18 is configured to activate the alarm means, when determining that vibration occurred to the structure.

The alarm means, for example, generates a sound and/or light and thereby threaten the intruder, and is arranged adjacent to the two optical fiber loops 2a and 2b. The vibration occurrence determining portion 18b triggers an “alert” or “warning” alarm in response to a detected vibration level (i.e. the sum of the outputs produced via the two optical fiber loops 2a and 2b), and notifies a user that the intrusion occurred. When the detected vibration level is not less than a predetermined intensity, the vibration occurrence determining portion 18b activates the alarm means.

Also, the vibration occurrence determining portion 18b may be configured to perform a Fourier transform on the vibration waveform produced by the optical fiber loops 2a and 2b, so as to analyze factors of the vibration from the frequency characteristics. According to this structure, it is possible to estimate whether the vibration is caused by a natural phenomenon, such as rain, wind, or by a human factor, and to activate the alarm means only when the vibration is caused by the human factor.

Alternatively, the optical fiber vibration sensor 1 may be configured to determine (identify) that the vibration occurred in the entire structure and determine that the vibration is caused by natural phenomenon such as wind or rain, if the vibration position determining portion 18c cannot determine (identify) the specific position in the structure where the vibration occurred while the vibration occurrence determining portion 18b determines that the vibration occurred to the structure. More concretely, the optical fiber vibration sensor 1 may be such configured that if the vibration occurrence determining portion 18b determines that the vibration occurred to the structure and thereafter the vibration position determining portion 18c carries out the determining process of the position where the vibration occurred but cannot determine the position of vibration, the vibration occurrence determining portion 18b determines that the vibration is caused by the natural phenomenon. Alternatively, the optical fiber vibration sensor 1 may be such configured that the signal processing unit 18 carries out parallel processing of determining the vibration occurrence by the vibration occurrence determining portion 18b and determining the position of the vibration occurrence by the vibration position determining portion 18c, and if the position of the vibration occurrence cannot be determined while the vibration occurrence is determined, it is determined as the vibration caused by the natural phenomenon (i.e. it is determined as the vibration caused by the human factor if the vibration is determined and the position of the vibration occurrence is determined. In other cases, it is determined (considered) as there is no vibration occurrence).

(Detection Sensitivity of the Optical Fiber Vibration Sensor 1)

Next, the sensitivity of the optical fiber vibration sensor 1 for detecting the vibration (hereinafter referred to as “the detection sensitivity” of the optical fiber vibration sensor 1) will be explained below.

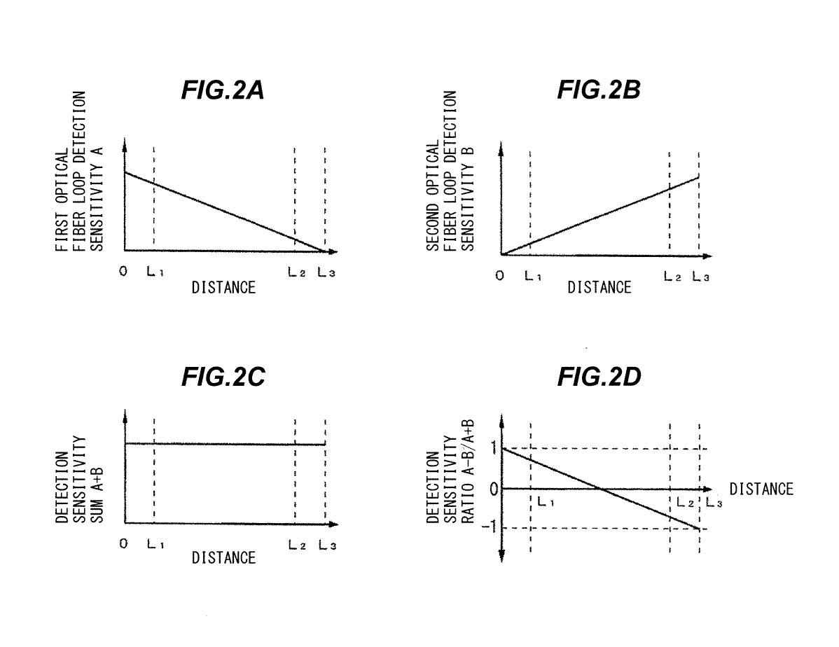

Referring to FIG. 2A, the detection sensitivity A of the first optical fiber loop 2a gradually decreases with distance from the reference point 0 to L₃, i.e. from the base end to the tip end of the first optical fiber loop 2a.

Referring to FIG. 2B, in contrast, the detection sensitivity B of the second optical fiber loop 2b gradually increases with distance from the reference point 0 to L₃, i.e. from the tip end to the base end of the second optical fiber loop 2b.

Referring to FIG. 2C, the sum of the detection sensitivities A and B (i.e. A+B) is a constant value. From this, following relationship is confirmed. Specifically, the detection sensitivity in the longitudinal direction of the optical fiber loops 2a and 2b can be made uniform by configuring the vibration occurrence determining portion 18b to determine the occurrence of vibration based on the sum of the outputs produced via the two optical fiber loops 2a and 2b. Therefore, it is possible to provide the excellent detection sensitivity over the entire longitudinal length of the optical fiber loops 2a and 2b (i.e. there is no point where the detection sensitivity thereof is zero over the optical fiber loops 2a and 2b).

Referring also to FIG. 2D, the detection sensitivity ratio value gradually decreases from 1 to −1 with distance from the reference point 0 to L₃. Herein, the detection sensitivity ratio value is calculated by dividing the difference between the detection sensitivities A and B by the sum of the detection sensitivities A and B. In FIG. 2D, the vertical axis indicates the detection sensitivity ratio. Alternatively, the vertical axis may indicate the output ratio, which is calculated by dividing the difference between the outputs produced via the two optical fiber loops 2a and 2b by the sum of the outputs produced via the two optical fiber loops 2a and 2b. In this case, the relationship similar to that in FIG. 2D will be established, therefore it is possible to determine at which point in the distance range from 0 to L₃ the vibration occurred.

The reason for using not only the difference between the outputs of both the optical fiber loops 2a and 2b but also the output ratio calculated by dividing the output difference by the sum of the outputs thereof is as follows. Since the output difference varies in accordance with the intensity of the vibration occurred in the structure, it is difficult to determine at which point the vibration occurred based on only the output difference. That is, the use of the above described output ratio allows the normalization, thereby making it possible to determine at which point the vibration occurred, regardless the magnitude of the intensity of the vibration.

(Operation of the Optical Fiber Vibration Sensor 1)

Next, the operation of the optical fiber vibration sensor 1 will be explained.

In both the vibration sensor main bodies 3a and 3b, the light waves emitted from the light sources 11 are propagated through the first optical couplers 13, linearly polarized by the polarizers 14, and passed into the second optical couplers 15, respectively. At the second optical coupler 15 of the first vibration sensor main body 3a, the light wave passed into the second optical coupler 15 is split into two light waves, and the two split light waves are passed through different ends, respectively, of the first optical fiber loop 2a, while at the second optical coupler 15 of the second vibration sensor main body 3b, the light wave passed into the second optical coupler 15 is similarly split into two light waves, and the two split light waves are passed through different ends, respectively, of the second optical fiber loop 2b.

The light waves propagated clockwise and counterclockwise, respectively, around the first optical fiber loop 2a are phase modulated by the phase modulator 16 on the first optical fiber loop 2a, and passed all the way around the first optical fiber loop 2a, again into the second optical coupler 15 of the first vibration sensor main body 3a, while the light waves propagated clockwise and counterclockwise, respectively, around the second optical fiber loop 2b are similarly phase modulated by the phase modulator 16 on the second optical fiber loop 2b, and passed all the way around the second optical fiber loop 2b, again into the second optical coupler 15 of the second vibration sensor main body 3b. At each of the second optical couplers 15, the clockwise and counterclockwise light waves passed thereinto interfere with each other, resulting in an interfering light wave. These interfering light waves are propagated through the polarizers 14 respectively, and each again split by the first optical couplers 13 into two light waves, and one of the two split light waves is received in the light receivers 12.

When the first and second optical fiber loops 2a and 2b do not vibrate, the light receivers 12 detect a constant light intensity at all times. On the other hand, when the first and second optical fiber loops 2a and 2b vibrate, the clockwise and counterclockwise light waves propagating around each of the first and second optical fiber loops 2a and 2b have a phase difference, and the light intensity detected by the light receivers 12 varies. Because the light intensity received by the light receivers 12 is proportional to a sine of the phase difference between the clockwise and counterclockwise light waves, the vibration caused to the first and second optical fiber loops 2a and 2b is increased in accordance with the increase in the phase difference, and the variation in the light intensity received by the light receivers 12 is increased.

The phase difference detecting portions 18a of the signal processing units 18 detect the variations in the light intensities received by the light receivers 12, respectively, based on the electrical signals from the light receivers 12, and detect the phase difference between the clockwise and counterclockwise light waves propagating around the first optical fiber loop 2a and the phase difference between the clockwise and counterclockwise light waves propagating around the second optical fiber loop 2b, respectively. The phase difference detecting portion 18a of the second vibration sensor main body 3b transmits the detected phase difference to the signal processing unit 18 of the first vibration sensor main body 3a, via the cable 20.

The vibration occurrence determining portion 18b of the first vibration sensor main body 3a computes the sum of the phase difference detected by the phase difference detecting portion 18a of the first vibration sensor main body 3a, and the phase difference detected by the phase difference detecting portion 18a of the second vibration sensor main body 3b, i.e. the sum of the outputs produced via the two optical fiber loops 2a and 2b. When the value of the sum exceeds a predetermined threshold, the vibration occurrence determining portion 18b determines that vibration occurred to the structure. When determining that vibration occurred to the structure, the vibration occurrence determining portion 18b activates the alarm means according to the magnitude of the sum of the outputs as mentioned above. Herein, although the phase differences is used as the outputs produced via the two optical fiber loops 2a and 2b respectively, the variations per se in the light intensities received by the light receivers 12 may be used as the outputs of the two optical fiber loops 2a and 2b respectively.

The vibration position determining portion 18c of the first vibration sensor main body 3a computes the output ratio by dividing the difference between the outputs (phase differences) produced via the two optical fiber loops 2a and 2b by the sum of the outputs (phase differences) produced via the two optical fiber loops 2a and 2b. Based on that output ratio, the vibration position determining portion 18c determines a position where the vibration occurred to the structure. The vibration position determining portion 18c notifies the user of the determined position where the vibration occurred, by e.g. displaying the determined position on a monitor or the like (not shown).

### Function and Effects of the First Embodiment

Next, the function and effects of the first embodiment will be explained below.

The optical fiber vibration sensor 1 in this embodiment includes the two optical fiber loops 2a and 2b arranged in such a manner that at least parts in the longitudinal direction are arranged adjacent to and along each other, so that the sensitivity of one optical fiber loop 2a for detecting the vibration decreases with the distance from the one end to the other end, while the sensitivity of the other optical fiber loop 2b for detecting the vibration increases with the distance from the one end to the other end. The optical fiber vibration sensor 1 determines whether vibration occurred to the structure based on the sum of the outputs produced via the two optical fiber loops 2a and 2b, and determines the position where the vibration occurred to the structure based on the output ratio of the difference between the outputs produced via the two optical fiber loops 2a and 2b divided by the sum of the outputs produced via the two optical fiber loops 2a and 2b.

According to this structure, there is no point where the detection sensitivity is zero over the entire longitudinal length of the two optical fiber loops 2a and 2b, so that the detection sensitivity is good over the entire longitudinal length. Further, it is possible to pinpoint more minutely the position where the vibration occurred to the structure, i.e. the intruder has intruded.

Still further, the optical fiber vibration sensor 1 also includes the two optical fiber loops 2a and 2b each formed by joining together the respective tip ends of the two optical fibers arranged in parallel and along each other. For example, in each of the first and second optical fiber loops 2a and 2b, if the optical fiber (serving as the forward path) from one end thereof to the halfway point therearound and the optical fiber (serving as the return path) from that halfway point to the other end are widely distant from each other, the effect of the vibration will be one-sided to cause an error. As a result, it is impossible to precisely determine the position where the vibration occurred. In this embodiment, however, such an error does not occur because the optical fibers serving as the forward path and the return path are arranged in parallel and along each other.

### Variations of the First Embodiment

Next, the first to third variations of the first embodiment will be explained below.

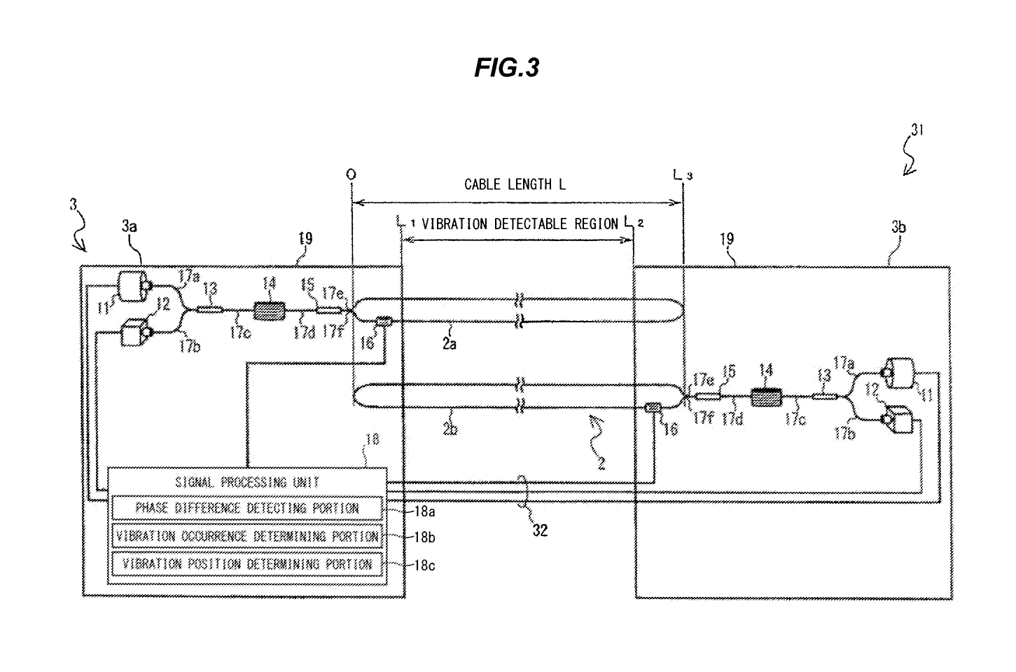

FIG. 3 shows an optical fiber vibration sensor 31 in the first variation, which is similar to the optical fiber vibration sensor 1 of FIG. 1, except that only one (single) signal processing unit 18 is mounted on the first vibration sensor main body 3a, by integrating the signal processing units 18. The light source 11, the light receiver 12, and the phase modulator 16 within the second vibration sensor main body 3b are electrically connected with the signal processing unit 18 within the first vibration sensor main body 3a, via cables 32, respectively. In the case that electrical signals produced by the light receivers 12 are weak, the optical fiber vibration sensor 31 may further comprise amplifiers for amplifying electrical signals from the light receivers 12, respectively. In this case, the amplifiers having the same gain may be provided, respectively, between the light receiver 12 and the signal processing unit 18 within the first vibration sensor main body 3a, and between the light receiver 12 within the second vibration sensor main body 3b and the cable 32 connected therewith.

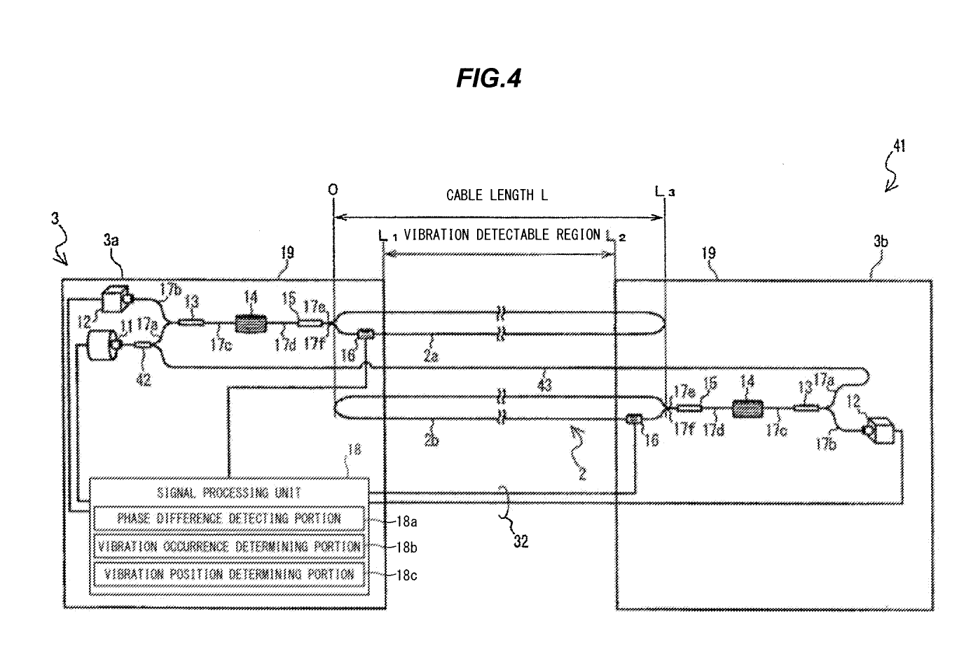

FIG. 4 shows an optical fiber vibration sensor 41 in the second variation, which is similar to the optical fiber vibration sensor 31 of FIG. 3, except that a common light source 11 is provided on the first vibration sensor main body 3a, by further integrating the light sources 11. In the optical fiber vibration sensor 41, a light wave from the light source 11 is split by a third optical coupler 42 into two light waves, and one of the two split light waves is passed through the first optical coupler 13 within the first vibration sensor main body 3a, while the other of the two split light waves is passed through the first optical coupler 13 within the second vibration sensor main body 3b via a relaying optical fiber 43 connecting between both the first and second vibration sensor main bodies 3a and 3b.

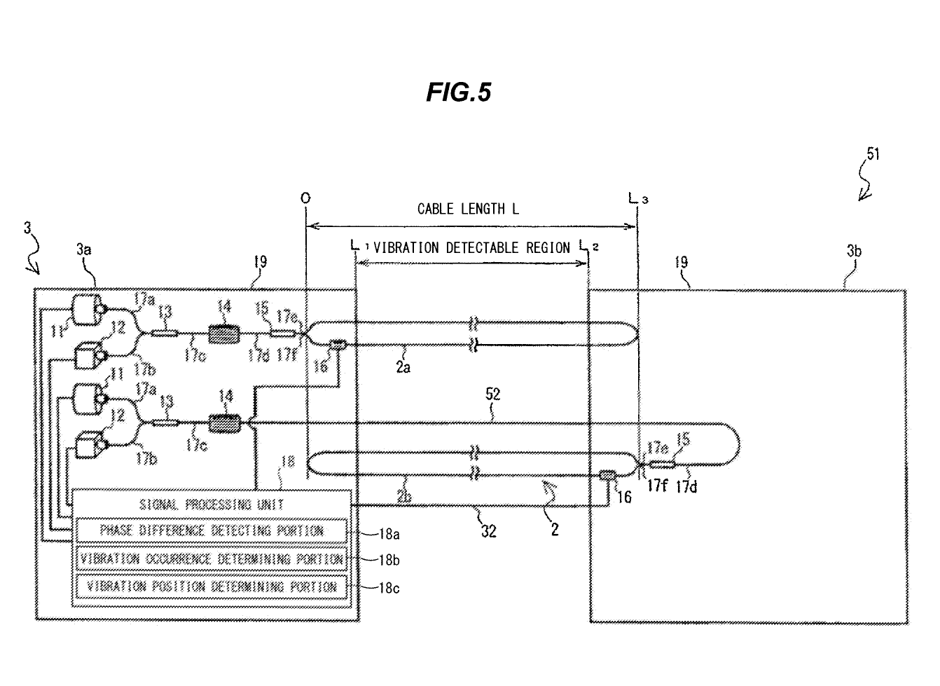

FIG. 5 shows an optical fiber vibration sensor 51 in the third variation, which is similar to the optical fiber vibration sensor 31 of FIG. 3, except that the light source 11, the light receiver 12, the first optical coupler 13, and the polarizer 14 are transferred from the second vibration sensor main body 3b to the first vibration sensor main body 3a. A light wave from that transferred polarizer 14 is passed through the second optical coupler 15 within the second vibration sensor main body 3b via a relay optical fiber 52 connecting between both the first and second vibration sensor main bodies 3a and 3b. Alternatively, in the optical fiber vibration sensor 51, the light sources 11 may naturally be integrated as a common light source.

### Second Embodiment

Next, a second embodiment according to the invention will be explained below.

(Structure of Optical Fiber Vibration Sensor 61)

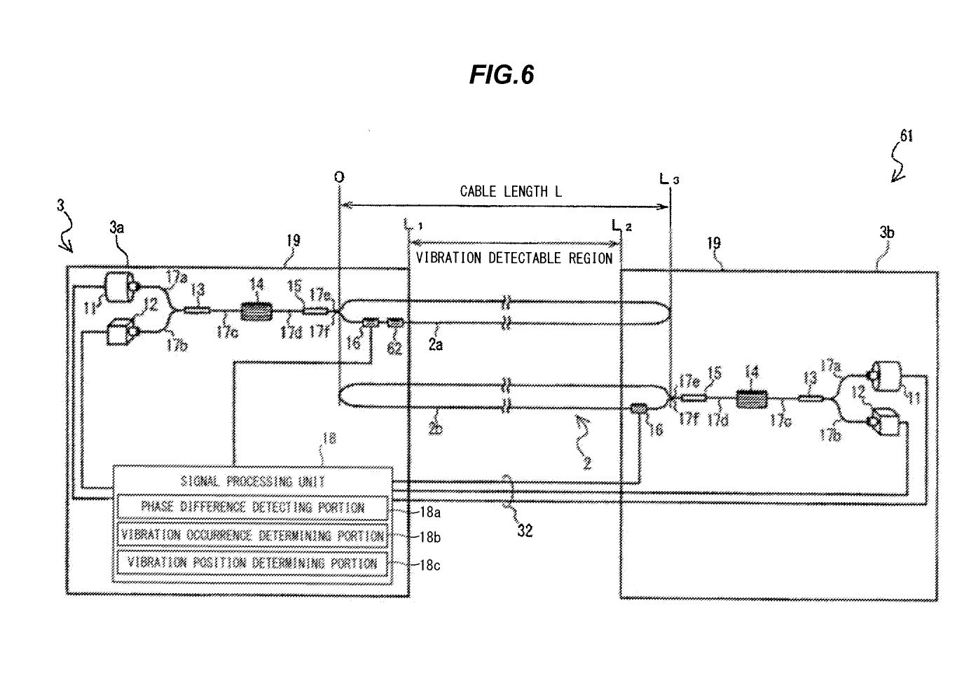

FIG. 6 shows an optical fiber vibration sensor 61, which is similar to the optical fiber vibration sensor 31 of FIG. 3, except a delaying optical fiber (or delaying optical fiber coil) 62 is formed in the first optical fiber loop 2a.

The first optical fiber loop 2a is formed in such a manner that at least half an entire length of optical fibers constituting the first optical fiber loop 2a is coiled and accommodated in the first vibration sensor main body 3a as the delaying optical fiber 62. Although the delaying optical fiber 62 is formed at an end on the side of a phase modulator 16 (lower end in FIG. 6) of the first optical fiber loop 2a, the delaying optical fiber 62 may be formed at an end (upper end in FIG. 6) on the side opposite to the phase modulator 16 of the first optical fiber loop 2a.

(Detection Sensitivity of the Optical Fiber Vibration Sensor 61)

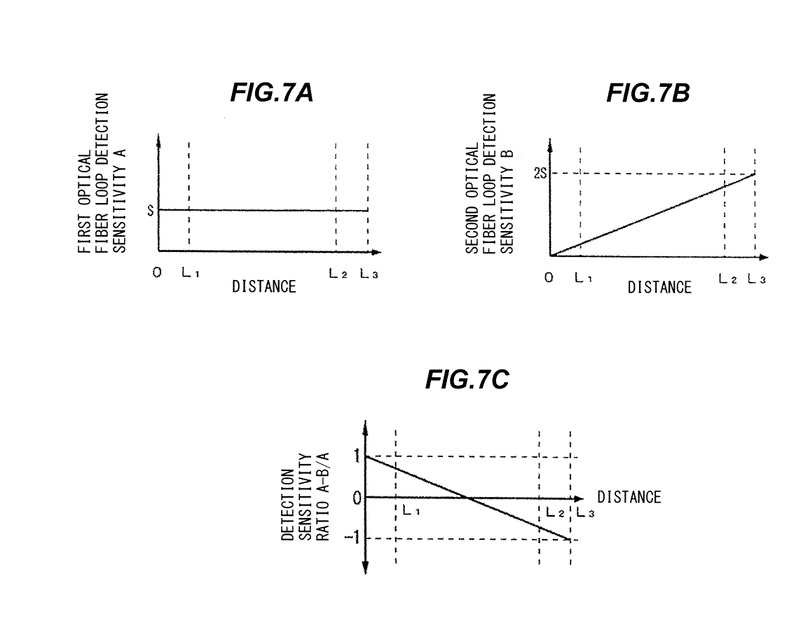

By forming the delaying optical fiber 62, the point where the detection sensitivity is zero is included in the delaying optical fiber 62. Referring to FIG. 7A, the detection sensitivity A of the first optical fiber loop 2a is a constant value in the longitudinal direction.

Referring to FIG. 7B, in contrast, the detection sensitivity B of the second optical fiber loop 2b gradually increases with distance from the reference point 0 to L₃, i.e. from the tip end to the base end of the second optical fiber loop 2b.

Herein, the detection sensitivity A of the first optical fiber loop 2a is S, while the detection sensitivity B at the base end of the second optical fiber loop 2b is 2S. FIG. 7C shows the detection sensitivity ratio, which is calculated by dividing the difference between the detection sensitivities A and B of both the optical fiber loops 2a and 2b by the detection sensitivity A of the first optical fiber loop 2a, which is the same as the detection sensitivity ratio of the optical fiber vibration sensor 1 shown in FIG. 2D. The relationship between the detection sensitivities A and B of both the optical fiber loops 2a and 2b is not limited thereto, but the detection sensitivity B at the base end of the second optical fiber loop 2b may be not double the detection sensitivity A of the first optical fiber loop 2a. In this case, the slope of the graph shown in FIG. 7C is changed, or the entire graph is vertically translated, but the characteristics are basically the same.

In the optical fiber vibration sensor 61, the vibration position determining portion 18c is configured to determine, a position where the vibration occurred to the structure based on an output ratio of outputs produced via the two optical fiber loops 2a and 2b. Herein, the “output ratio” refers to Xb/Xa in which the output (phase difference) of the first optical fiber loop 2a is Xa and the output (phase difference) of the second optical fiber loop 2b is Xb. Namely, the “output ratio” in the second embodiment is a value which is calculated by simply dividing the output Xb of the second optical fiber loop 2b by the output Xa of the first optical fiber loop 2a, and differs from the output ratio explained in the first embodiment. Alternatively, (Xa−Xb)/Xa may be used for the determination similarly to the aforementioned detection sensitivity ratio. However, since (Xa—Xb)/Xa can be transformed into −(Xb/Xa−1), the difference is only that the determination is made by use of an inverted and translated graph with Xb/Xa on the vertical axis and distance on the horizontal axis, and therefore the determination using (Xa−Xb)/Xa is essentially the same as the determination using Xb/Xa.

Also, in the optical fiber vibration sensor 61, the vibration occurrence determining portion 18b is configured to determine whether vibration occurred to the structure based on a sum of the outputs produced via the two optical fiber loops 2a and 2b, similarly to the optical fiber vibration sensor 1 in the first embodiment. Alternatively, the vibration occurrence determining portion 18b may be configured to determine whether vibration occurred to the structure based on only the output of the first optical fiber loop 2a having a constant detection sensitivity, since the first optical fiber loop 2a having the constant detection sensitivity is disposed over the entire vibration detectable region (i.e. measurement region) in the optical fiber vibration sensor 61.

### Variations of the Second Embodiment

Next, first and second variations of the second embodiment will be explained below.

(Structure of Optical Fiber Vibration Sensor 81)

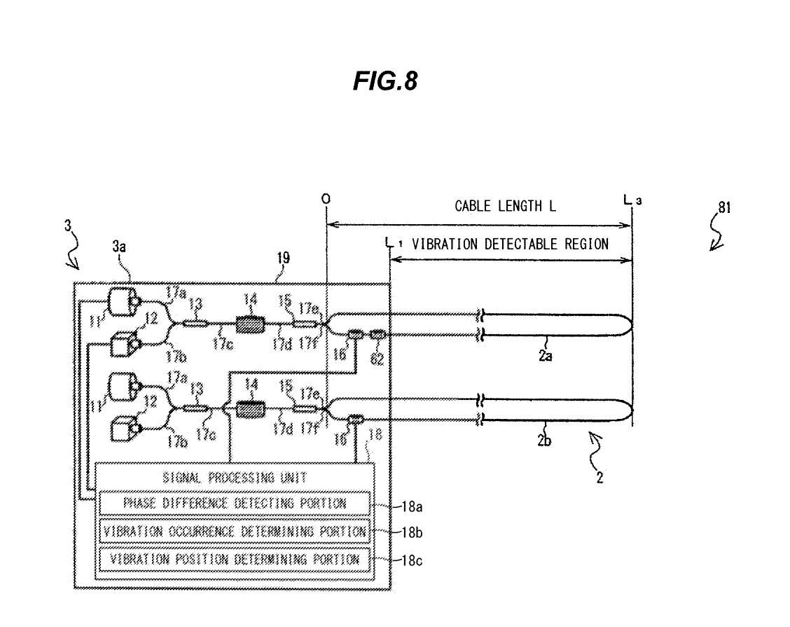

FIG. 8 shows an optical fiber vibration sensor 81 is similar to the optical fiber vibration sensor 61 of FIG. 6 except that the light source 11, the light receiver 12, the first optical coupler 13, the polarizer 14, the second optical coupler 15 and the phase modulator 16 are transferred from the second vibration sensor main body 3b to the first vibration sensor main body 3a, the second vibration sensor main body 3b is omitted, and the orientation of the second optical fiber loop 2b is reversed, so that the two optical fiber loops 2a and 2b are arranged to have such a common orientation that respective base ends and tip ends of the two optical fiber loops 2a and 2b are aligned with each other. This optical fiber vibration sensor 81 has the vibration detectable region ranging from the distance L₁ to the distance L₃.

In the optical fiber vibration sensor 81, the two optical fiber loops 2a and 2b have the same length. However, the present invention is not limited thereto. The two optical fiber loops 2a and 2b may differ in length, as long as detection is not delayed. In this case, however, the length of the first optical fiber loop 2a having the constant detection sensitivity should be not shorter than the length of the second optical fiber loop 2b having the slope in detection sensitivity. More specifically, if the second optical fiber loop 2b is longer than the first optical fiber loop 2a, there can be a region in which only the second optical fiber loop 2b is arranged. In this region, the tip end of the second optical fiber loop 2b is disposed. The tip end of the second optical fiber loop 2b has the low detection sensitivity and includes the halfway point where the detection sensitivity is zero. Therefore, it is impossible to accurately detect the vibration in this region.

On the other hand, in the optical fiber vibration sensor 61 of FIG. 6, there is no problem even though the length of the first optical fiber loop 2a is shorter than the length of the second optical fiber loop 2b, since the two optical fiber loops 2a and 2b are arranged in the mutually opposite orientations.

In the case that the first optical fiber loop 2a is formed to be longer than the second optical fiber loop 2b, the vibration position determining portion 18c may be configured to determine that the vibration occurred in the region in which only the first optical fiber loop 2a is arranged, when the vibration is detected at only the first optical fiber loop 2a but not at the second optical fiber loop 2b.

(Detection Sensitivity of the Optical Fiber Vibration Sensor 81)

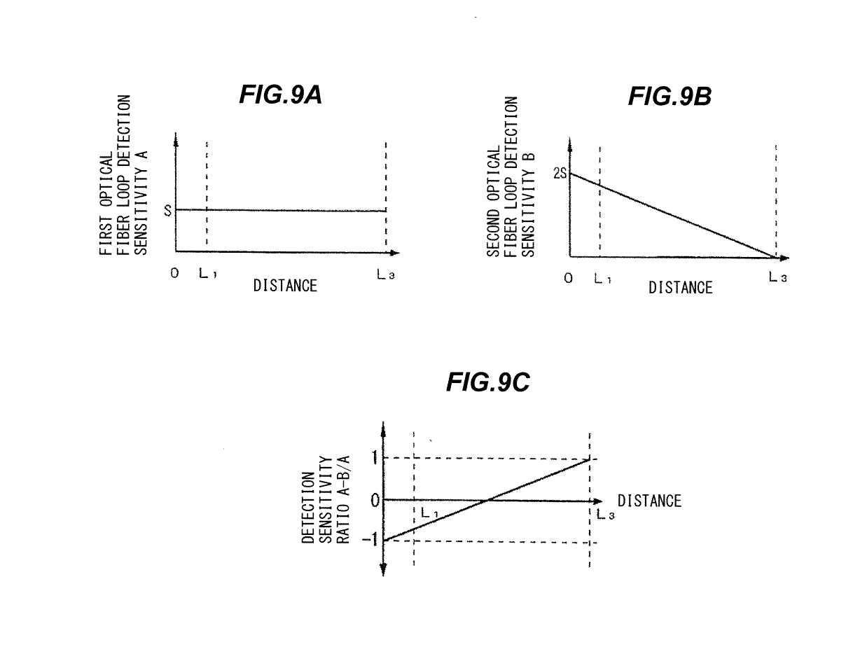

Referring to FIG. 9A, in the optical fiber vibration sensor 81, the detection sensitivity A of the first optical fiber loop 2a is a constant value in the longitudinal direction. On the other hand, referring to FIG. 9B, the detection sensitivity B of the second optical fiber loop 2b gradually decreases with distance from the reference point 0 to L₃, i.e. from the base end to the tip end of the second optical fiber loop 2b.

Herein, the detection sensitivity A of the first optical fiber loop 2a is S while the detection sensitivity B at the base end of the second optical fiber loop 2b is 2S. FIG. 9C shows a detection sensitivity ratio, which is calculated by dividing the difference between the detection sensitivities A and B of both the optical fiber loops 2a and 2b by the detection sensitivity A of the first optical fiber loop 2a, which is the reversal of left and right of the graph of the detection sensitivity ratio of the optical fiber vibration sensor 61 shown in FIG. 7C.

In the optical fiber vibration sensor 81, it is possible to make the entire device compact, since the second vibration sensor main body 3b is omitted.

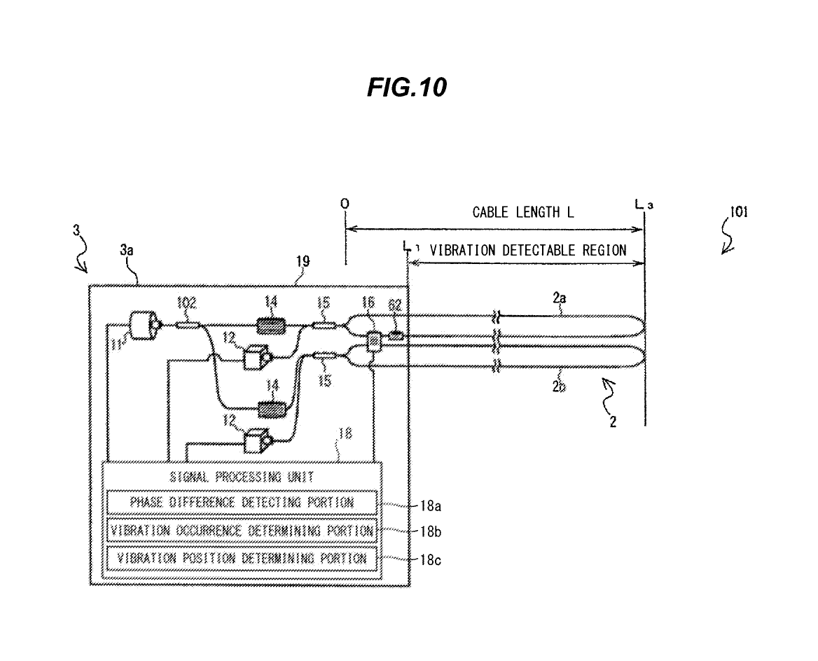

FIG. 10 shows an optical fiber vibration sensor 101 which is similar the optical fiber vibration sensor 81 of FIG. 8 except that a common light source 11 and a common phase modulator 16 are provided on the first vibration sensor main body 3a, by further integrating the light sources 11 and integrating the phase modulators 16. In the optical fiber vibration sensor 101, the first optical couplers 13 are omitted, a light wave from the light source 11 is split by a third optical coupler 102 into two light waves, and the two light waves are passed through the polarizers 14 respectively. Also, in the optical fiber vibration sensor 101, the second optical couplers 15 have 2×2 input/output ports (i.e. two input or output ports and two output or input ports), and the light receivers 12 are optically connected to the second optical couplers 15 respectively.

The phase modulator 16 may be formed by winding portions of optical fibers constituting each of the first and second optical fiber loops 2a and 2b around a common cylindrical piezo ceramic element (PZT).

According to the optical fiber vibration sensor 101, it is possible to decrease the number of the optical couplers, make the device more compact, and reduce the cost, since the optical fiber vibration sensor 101 has the common light source 11 and the common phase modulator 16.

### Third Embodiment

Next, a third embodiment according to the invention will be explained below.

(Structure of Optical Fiber Vibration Sensor 111)

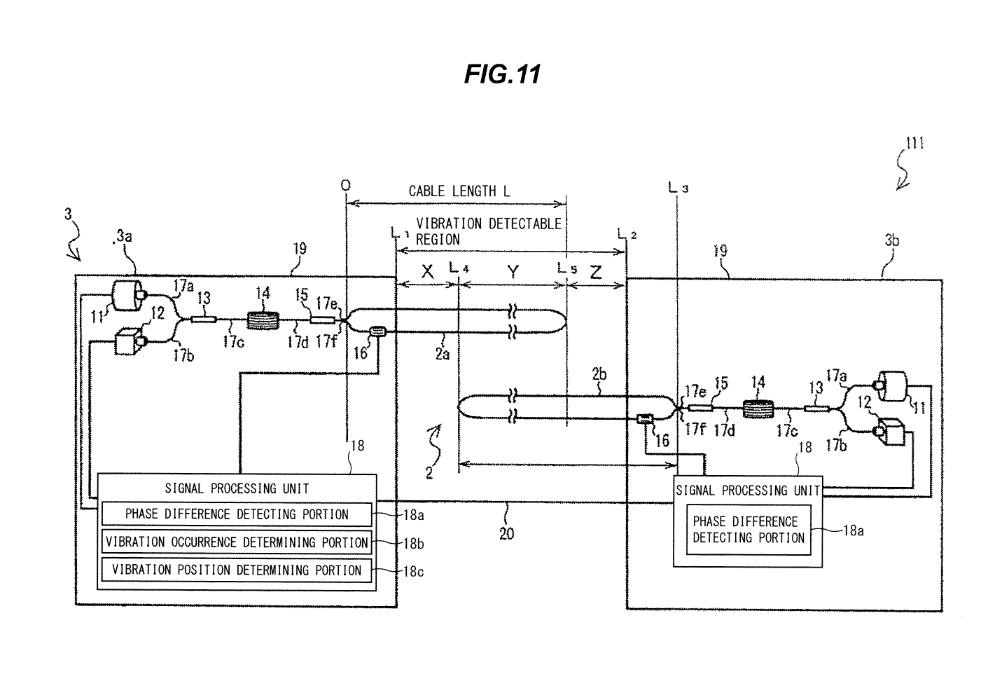

FIG. 11 shows an optical fiber vibration sensor 111, which is similar to the optical fiber vibration sensor 1 of FIG. 1 except that the first and second optical fiber loops 2a and 2b are arranged such that only the portions in the longitudinal direction are arranged along each other. Herein, since the first and second optical fiber loops 2a and 2b are arranged to have the mutually opposite orientations, the respective tip ends of the first and second optical fiber loops 2a and 2b are overlapped together. Herein, the base end of the first optical fiber loop 2a is taken as the reference point 0, the distance from the reference point 0 to the casing 19 for the first vibration sensor main body 3a is set at L₁, the distance from the reference point 0 to the tip end of the second optical fiber loop 2b is set at L₄, the distance from the reference point 0 to the tip end of the first optical fiber loop 2a is set at L₅, the distance from the reference point 0 to the casing 19 for the second vibration sensor main body 3b is set at L₂, and the distance from the reference point 0 to the base end of the second optical fiber loop 2b is set at L₃. The vibration detectable region ranges from the L₁ to L₂, and the region in which the first and second optical fiber loops 2a and 2b are both arranged ranges from the L₄ to L₅. Herein, the first and second optical fiber loops 2a and 2b have the same cable length L. The distance L₅ is equal to the cable length L of the first optical fiber loop 2a, and the distance (L₃−L₄) is equal to the cable length L of the second optical fiber loop 2b.

In the optical fiber vibration sensor 111, the vibration detectable region is composed of three regions: a region (herein referred to as “region X”) having the distance from L₁ to L₄ in which only the first optical fiber loop 2a is arranged; a region (herein referred to as “region Y”) having the distance from L₄ to L₅ in which both the first and second optical fiber loops 2a and 2b are arranged; and a region (herein referred to as “region Z”) having the distance from L₅ to L₂ in which only the second optical fiber loop 2b is arranged.

In the optical fiber vibration sensor 111, the vibration position determining portion 18c is configured to determine that the vibration occurred in the region X (or Z) in which only the optical fiber loop 2a (or 2b) detecting the vibration is arranged, when vibration is detected at only one optical fiber loop 2a (or 2b) of the two optical fiber loops 2a and 2b. Further, the vibration position determining portion 18c is configured to determine that the vibration occurred in the region Y in which both the optical fiber loops 2a and 2b are arranged, when vibration is detected at both the optical fiber loops 2a and 2b. Then, the vibration position determining portion 18c pinpoints a position where the vibration occurred to the structure in the region Y, based on the output ratio, which is calculated by dividing the difference between the outputs produced via the two optical fiber loops 2a and 2b by the sum of the outputs produced via the two optical fiber loops 2a and 2b.

(Detection Sensitivity of the Optical Fiber Vibration Sensor 111)

Next, the detection sensitivity of the optical fiber vibration sensor 111 will be explained below.

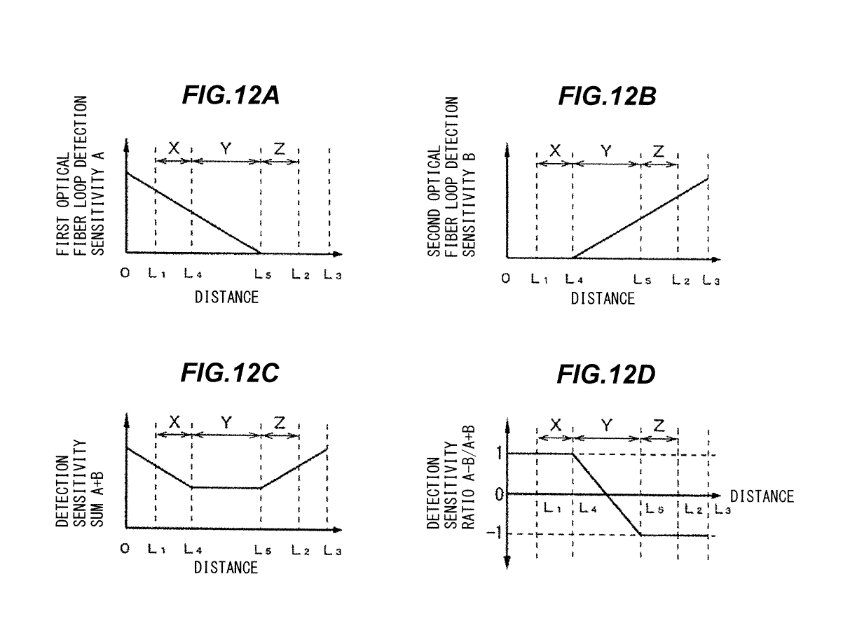

Referring to FIG. 12A, the detection sensitivity A of the first optical fiber loop 2a gradually decreases with distance from the reference point 0 to L₅, i.e. from the base end to the tip end of the first optical fiber loop 2a. Since the first optical fiber loop 2a is not arranged in the region having the distance from L₅ to L₃, the detection sensitivity A is zero in this region.

Referring to FIG. 12B, in contrast, the detection sensitivity B of the second optical fiber loop 2b gradually increases with distance from L₄ to L₃, i.e. from the tip end to the base end of the second optical fiber loop 2b. Since the second optical fiber loop 2b is not arranged in the region having the distance from 0 to L₄, the detection sensitivity B is zero in this region.

Referring to FIG. 12C, the sum of the detection sensitivities A and B (A+B) is equal to the detection sensitivity A of the first optical fiber loop 2a in the region X, is equal to the detection sensitivity B of the second optical fiber loop 2b in the region Z, and is a constant value in the region Y. Therefore, it is found that the detection sensitivity of the optical fiber loops 2a and 2b can be good over the entire longitudinal length thereof, by configuring the vibration occurrence determining portion 18b to determine the occurrence of vibration by taking the sum of the outputs produced via the two optical fiber loops 2a and 2b. The regions X and Z are adjacent to the base ends of the first and second optical fiber loops 2a and 2b respectively. Therefore, the detection sensitivity in the regions X and Y is naturally high, and the detection sensitivity in the region Y is enhanced by adding the outputs of the first and second optical fiber loops 2a and 2b together, so that there is no point where the detection sensitivity thereof is zero.

FIG. 12D shows the detection sensitivity ratio, which is calculated by dividing the difference between the detection sensitivities A and B by the sum of the detection sensitivities A and B. As shown in FIG. 12D, since the detection sensitivity B is 0 (B=0) in the region X, the detection sensitivity ratio is constant (i.e. (A−B)/(A+B)=1). Also, since the detection sensitivity A is 0 (A=0) in the region Z, the detection sensitivity ratio is constant (i.e. (A−B)/(A+B)=−1). In the region Y, the detection sensitivity ratio (A−B)/(A+B) gradually decreases from 1 to −1 with distance from L₄ to L₅. In the region Y, it is therefore possible to pinpoint at which position in the distance range from L₄ to L₅ the vibration occurred, based on the output ratio value, which is calculated by dividing the difference between the outputs produced via the two optical fiber loops 2a and 2b by the sum of the outputs produced via the two optical fiber loops 2a and 2b.

As described above, the optical fiber vibration sensor 111 can determine in which region of the three regions X, Y, and Z the vibration occurred, based on the result of the vibration detection in the two optical fiber loops 2a and 2b. Further, in the case that the vibration occurred in the region Y, it is possible to pinpoint at which position the vibration occurred based on the output ratio.

According to the optical fiber vibration sensor 111, even though the length (cable length L) of the optical fiber loops 2a and 2b is shortened, it is possible to detect vibration in the wide region, and identify the position where the vibration occurred, i.e. the intruder has intruded.

In the optical fiber vibration sensor 111, the vibration position determining portion 18c is configured to determine that the vibration occurred in the region X (or Z) in which only the optical fiber loop 2a (or 2b) detecting the vibration is arranged, when the vibration is detected at only one optical fiber loop 2a (or 2b) of the two optical fiber loops 2a and 2b. Alternatively, the vibration position determining portion 18c may be configured to determine that the vibration occurred in the region X when the output ratio is 1, or the vibration occurred in the region Z when the output ratio is −1.

In the third embodiment, the two optical fiber loops 2a and 2b have the same length. However, the present invention is not limited thereto. The two optical fiber loops 2a and 2b may differ in length, as long as detection is not delayed.

Further, one optical fiber loop 2a of the two optical fiber loops 2a and 2b may be provided with a delaying optical fiber, so that the detection sensitivity A of one optical fiber loop 2a is constant. In this case, when the vibration occurred in the region Y, the position where the vibration occurred may be determined, based on the output ratio, which is calculated by dividing the output of the other optical fiber loop 2b by the output of one optical fiber loop 2a.

The invention is not limited to the above embodiments, but various alterations may naturally be made without departing from the spirit and scope of the invention.

For example, although in the above embodiments, the two twin core optical fiber cables are used for forming the two optical fiber loops 2a and 2b respectively, there may be used a quad core optical fiber cable, cores of which are formed into two core pairs for forming the two optical fiber loops 2a and 2b respectively. For example, when the relaying optical fiber 43 as in the optical fiber vibration sensor 41 of FIG. 4 is required, a quin core optical fiber cable including that relaying optical fiber 43 may be used.

Although the invention has been described with respect to the specific embodiments for complete and clear disclosure, the appended claims are not to be thus limited but are to be construed as embodying all variations and alternative constructions that may occur to one skilled in the art which fairly fall within the basic teaching herein set forth.

What is claimed is:

1. A Sagnac interference type optical fiber vibration sensor, comprising:
two optical fiber loops arranged along a structure, at least respective longitudinal portions of the two optical fiber loops being arranged along each other such that a sensitivity of one of the two optical fiber loops for detecting a vibration decreases with a distance from one end to an other end, while a sensitivity of an other of the two optical fiber loops for detecting the vibration increases with a distance from the one end to the other end; and
a vibration sensor main body, which detects the vibration caused to the structure, via the two optical fiber loops, the vibration sensor main body including:
a vibration occurrence determining portion for determining whether the vibration occurred to the structure based on a sum of outputs produced via the two optical fiber loops; and
a vibration position determining portion for determining a position where the vibration occurred to the structure based on an output ratio,
wherein the output ratio is a difference between the outputs produced via the two optical fiber loops which is divided by the sum of the outputs produced via the two optical fiber loops.

2. The optical fiber vibration sensor according to claim 1, wherein the two optical fiber loops are arranged in mutually opposite orientations,
wherein a tip end of the other optical fiber loop is positioned on a base end side of the one optical fiber loop, and a base end of the other optical fiber loop is positioned on a tip end side of the one optical fiber loop.

3. A Sagnac interference type optical fiber vibration sensor, comprising:
two optical fiber loops arranged along a structure, at least respective longitudinal portions of the two optical fiber loops being arranged along each other such that a sensitivity of one of the two optical fiber loops for detecting a vibration is constant with a distance from one end to an other end, while a sensitivity of an other of the two optical fiber loops for detecting the vibration decreases or increases with a distance from the one end to the other end, and
a vibration sensor main body, which detects the vibration caused to the structure, via the two optical fiber loops, the vibration sensor main body including:
a vibration occurrence determining portion for determining whether the vibration occurred to the structure based on a sum of outputs produced via the two optical fiber loops, or an output produced via the one of the two optical fiber loops; and
a vibration position determining portion for determining a position where the vibration occurred to the structure based on an output ratio of the outputs produced via the two optical fiber loops.

4. The optical fiber vibration sensor according to claim 3, wherein the one of the two optical fiber loops includes a delaying optical fiber comprising an optical fiber having at least half an entire length of optical fibers constituting the one of the two optical fiber loops,
wherein the delaying optical fiber is accommodated in the vibration sensor main body.

5. The optical fiber vibration sensor according to claim 3, wherein the two optical fiber loops have a common orientation,
wherein respective base ends and tip ends of the two optical fiber loops are aligned with each other and a length of the one of the two optical fiber loops is not less than a length of the other of the two optical fiber loops.

6. The optical fiber vibration sensor according to claim 1, further comprising:
a common phase modulator comprising a common cylindrical piezo ceramic element wound with portions of optical fibers constituting each of the two optical fiber loops.

7. The optical fiber vibration sensor according to claim 1, wherein the vibration position determining portion determines that the vibration occurred in a region in which only one of the two optical fiber loops detecting the vibration is arranged, when the vibration is detected at only the one of the two optical fiber loops.

8. The optical fiber vibration sensor according to claim 1, wherein the vibration occurrence determining portion determines that the vibration occurred to the structure is caused by a natural phenomenon, if the vibration occurrence determining portion determines that the vibration occurred to the structure but the vibration position determining portion cannot determine the position where the vibration occurred to the structure.
